(19) United States
(12) Patent Application Publication
(10) Pub. No.: US 2022/0122574 A1
(43) Pub. Date: Apr. 21, 2022

(54) ACOUSTIC BOOTH ASSEMBLY

(71) Applicant: Studiospares Europe Ltd, Bedfordshire (GB)

(72) Inventor: David West, Bedfordshire (GB)

(73) Assignee: Studiospares Europe Ltd, Bedfordshire (GB)

(21) Appl. No.: 17/194,723

(22) Filed: Mar. 8, 2021

(30) Foreign Application Priority Data
Oct. 16, 2020 (GB) 2016491.9

(51) Int. Cl. G10K 11/168

(52) U.S. Cl. CPC G10K 11/168

(57) ABSTRACT

A portable acoustic booth comprises a cylindrical frame having a partially cylindrical shell section raised above the ground by legs, and each leg is retractable into the shell section. The inner walls of the shell section are lined with a sound absorbing material layer. The shell section comprises tubular framework holding at least one curved panel. Each curved panel includes a plurality of elongate cut-outs.

### FIELD OF THE INVENTION

The present invention relates to an acoustic or sound booth assembly. In particular, the invention relates to an acoustic booth assembly for the vocal market that can be easily transported and stored. Additionally, the invention relates to portable acoustic booth which includes a frame incorporating a sound treatment layer.

### BACKGROUND TO THE INVENTION

Those working in the vocal industry such as singers, voice-over artists, broadcasters and podcasters often find themselves in need of a temporary vocal booth that can be easily transported and stored when travelling to collaborate with others in their field.

Creating a good sounding environment for quality sound recordings in neutral settings is a common issue. The solution usually involves acoustically treating the room which is expensive and time-consuming to set up, typically using rigid constructions.

Sound booths are commercially available for installation in a room but the costs are often prohibitive. There is a need for a affordable, lightweight and portable sound booth assembly which is able to provide high quality sound.

### SUMMARY OF THE INVENTION

According to the present invention there is provided A portable acoustic booth comprising a substantially cylindrical frame having a partially cylindrical shell section raised above the ground by at least one leg, wherein the inner walls of the shell section are lined with a sound absorbing material layer.

Preferably, the shell section comprises tubular framework holding at least one curved panel.

Preferably, wherein the or each panel includes a plurality of elongate cut-outs.

Preferably, the shell section comprises at least two curved panels slidable with respect to each other to allow the frame shell section to fold.

Preferably, the or each leg is retractable into the shell section.

Preferably, the frame is constructed from aluminium.

Preferably, the material layer comprises at least one layer of serge wool and a layer of acoustic foam.

Preferably, the foam layer is formed from a plurality of aligned pyramidal structures.

Preferably, the frame further comprises a roof structure.

### BRIEF DESCRIPTION OF THE DRAWINGS

The invention will now be described by way of example only with reference to the accompanying drawings in which:-

FIG. 1 is a side perspective view of a sound booth frame constructed in accordance with the present invention;

FIG. 2 is a front perspective view of the frame of FIG. 1;

FIG. 3 is an exploded view of the frame;

FIG. 4 is a view of the inside of the booth assembly;

FIG. 5 show the front, side and end views of a sound enhancing layer which lines the frame of FIGS. 1 and 2 to provide the assembly; and

FIG. 6 is a perspective view of the sound enhancing layer of FIG. 5.

### DETAILED DESCRIPTION OF THE INVENTION

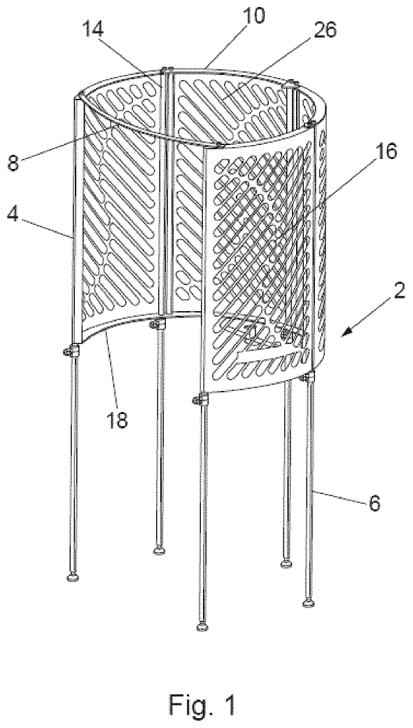

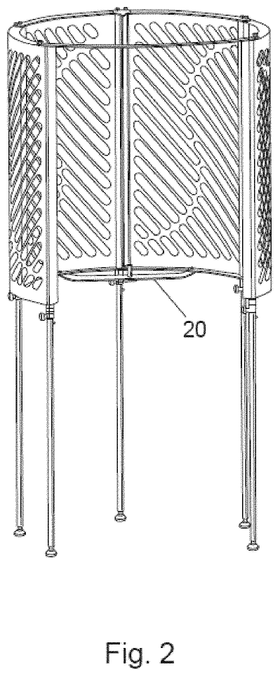

A frame 2 of an acoustic or sound booth assembly constructed in accordance with the invention is shown in FIGS. 1 and 2.

The frame 2 is typically made from a lightweight metal such as aluminium but can be made of any suitable material to form an enclosure as hereinafter described. It could be made for example of stainless steel or plastic.

When fully assembled for use, the frame 2 comprises a partially cylindrical shell structure 4 raised above the ground by legs 6.

The shell 4 is partially cylindrical in that it has rear wall and side walls which are curved to form a generally cylindrical shaped space with an opening at the front through which a user can enter to stand inside the shell 4.

A top bar 8 extends across the top of the frame 2 across the opening to form a complete generally cylindrical support frame 10 across the top to receive a roof or ceiling panel 12. The roof 12 may be removable.

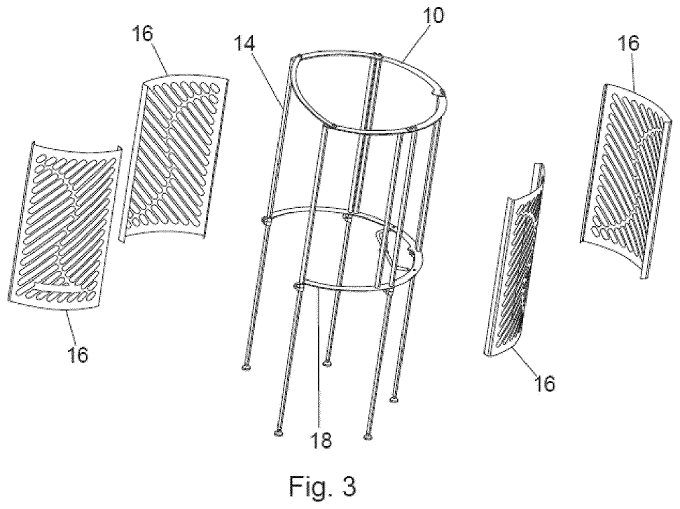

As can be seen in the exploded view in FIG. 3, the frame 2 comprises tubular frame members 14 holding four curved panels 16. The vertically orientated tubular members 14 are rotatable or movable about the top support frame 10 and a lower horizontally orientated support frame 18 to allow the panels 16 to slide in respect to each other so to collapse or fold the frame 2 for storage and/or transportation.

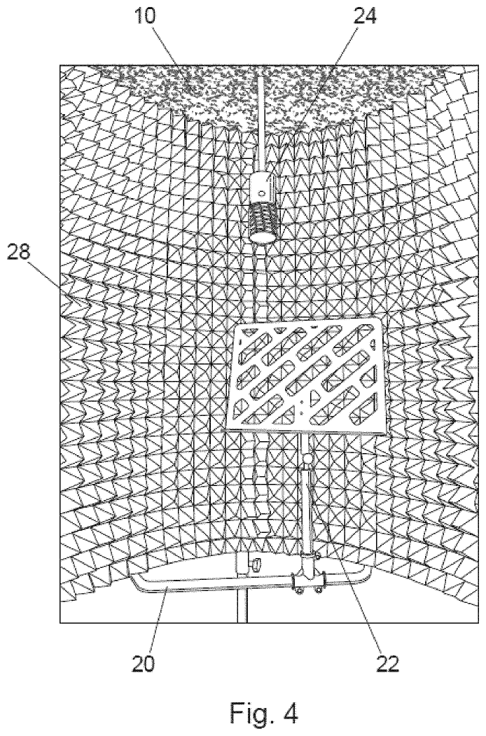

A secondary generally U-shaped tubular frame 20 extends inwardly from the lower support frame 18 which, in use, provides a horizontally orientated beam within the shell 4 to which can be secured a musical stand 22, as can be seen in FIG. 4.

In FIG. 4 the ceiling panel 10 can also be seen extending over the shell 4 secured to the top support frame 10. A microphone 24 extends downwardly from the ceiling panel 10.

The curved panels 16 are made from sheet metal, such as aluminium that is bent to shape.

Each panel 16 is formed with a plurality of elongate cut-outs or open slots 26 which enhance the sound quality by allowing the sound to “breath” within the shell 4 and also help to reduce to overall weight of the frame 2. The applicant has found that having solid wall panels would have a negative effect on the sound quality. The cut-outs 26 are strategically aligned in a regular pattern across the panels 16 to provide consistent sound treatment within the shell 4.

The frame 2 is substantially cylindrical to eliminate standing waves, which are caused by corners and which result in low frequency sound absorption or ‘bass trapping’, ultimately limiting the ‘boxy’ dead sound.

The legs 6 are able to retract into the frame 2 to adjust the height of the shell 4. The legs 6 may be telescopic. They may be fully retractable or removable for storage and/or transportation.

Turning now to FIGS. 4 to 6, sound treatment is provided an acoustic layer 28 secured to the inside walls of the shell 4. The acoustic layer 28 is itself formed of three layers of sound treatment. The layers consist of two layers of serge wool 30 and a layer of 30d foam 32.

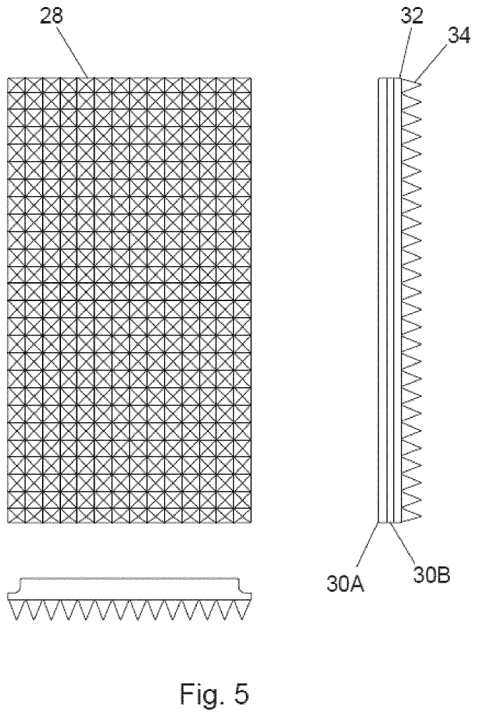

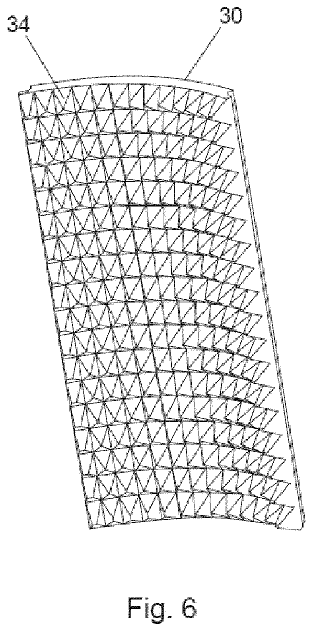

As can be seen in FIGS. 5 and 6, the 30d foam layer 32 is formed with an array of foam pyramidal structures 34 aligned in a regular form and secured to each other at their base.

The outer serge wall layer 30A of the acoustic layer 28 is adhered or otherwise attached or secured to the inside of the shell 6 such that the pyramids 34 of the foam layer 32 extend inwardly into the booth.

The frame 2 is foldable and portable making it ideal for those that require an easily movable booth and has comparable quality to expensive non-mobile sound treatment booths. The construction of the vocal booth offers sound treatment as well as some sound proofing, with noise reduction of up to 20 dB between 16 kH and 20 kH. The reverberation time has been recorded as being 0.09 seconds which makes it perfect for vocal applications and is comparable to many installed booths that are ten times the cost.

1. A portable acoustic booth comprising a cylindrical frame having a partially cylindrical shell section raised above the ground by at least one leg, wherein the inner walls of the shell section are lined with a sound absorbing material layer.

2. The portable acoustic booth according to claim 1, wherein shell section comprises tubular framework holding at least one curved panel.

3. The portable acoustic booth according to claim 2, wherein each curved panel includes a plurality of elongate cut-outs.

4. The portable acoustic booth according to claim 2, wherein shell section comprises at least two curved panels slidable with respect to each other to allow the cylindrical frame section to fold.

5. The portable acoustic booth according to claim 1, wherein the each leg is retractable into the shell section.

6. The portable acoustic booth according to claim 1, wherein the cylindrical frame is constructed from aluminium.

7. The portable acoustic booth according to claim 1, wherein the material layer comprises at least one layer of serge wool and a layer of acoustic foam.

8. The portable acoustic booth according to claim 7, wherein the foam layer is formed from a plurality of aligned pyramidal structures.

9. The portable acoustic booth according to claim 1, wherein the cylindrical frame further comprises a roof structure.

10. The portable acoustic booth according to claim 2, wherein the shell section further comprises a top support frame and a lower support frame, wherein the tubular framework is rotatable about the top support frame and the lower support frame to allow the cylindrical frame to fold.

11. The portable acoustic booth according to claim 1, wherein the shell section comprises a lower support frame having a U-shaped tubular frame that provides a horizontally orientated beam within the shell section.
